(19) United States
(12) Patent Application Publication
(10) Pub. No.: US 2023/0016547 A1
(43) Pub. Date: Jan. 19, 2023

(54) CABLE

(71) Applicant: Tsun Yi KO, Taipei City (TW)

(72) Inventor: Tsun Yi KO, Taipei City (TW)

(21) Appl. No.: 17/474,648

(22) Filed: Sep. 14, 2021

(30) Foreign Application Priority Data
Jul. 15, 2021 (TW) 110126140

(51) Int. Cl. H01B 7/22; H01B 7/18; H01B 7/02

(52) U.S. Cl. CPC H01B 7/226; H01B 7/183; H01B 7/02

(57) ABSTRACT

A cable is provided. The cable comprises a conductor for transmitting electrical signals, an insulating layer covering the conductor along the length direction of the cable, and a shield layer covering the insulating layer along the length direction of the cable. The shield layer comprises multiple conductive flat wires which are spirally wound along the length direction of the cable to cover the insulating layer, and the conductive flat wires are parallel to each other and do not overlap with each other.

### CROSS REFERENCE TO RELATED APPLICATIONS

The present invention claims priority under 35 U.S.C. § 119 to Taiwan Patent Application No. 110126140 filed on Jul. 15, 2021, the entire content of which is incorporated herein by reference.

### BACKGROUND OF THE INVENTION

### Field of the Invention

The invention relates to a cable, more specifically a cable that comprises a shield layer consisting of multiple conductive flat wires.

### Descriptions of the Related Art

The cable typically consists of a conductive core, an insulating layer covering the conductive core, a conductive layer covering the insulating layer, and a protective sheath, wherein the conductive layer that covers the insulating layer is a shield layer for preventing external signals from entering into the conductive core and thus influencing signal transmission.

The shield layer typically consists of wire mesh or metal foils. However, the wire mesh is formed of metal wires overlapped with each other, and the overlap of the metal wires results in increased layer thickness and interstices. In addition, when using metal foils to provide the shield layer, longitudinal wrapping (also called “cigar wrapping”) is typically applied, and such wrapping also results in increased layer thickness. Though the thickness of the shield layer can be lowered by using thinner metal foils, using thinner metal foils will result in poor mechanical reliability and high process difficulty.

### SUMMARY OF THE INVENTION

The invention provides a cable that requires less manufacturing time and cost and does not have the aforementioned overlap issue. For a given cable size, the cable of the invention has a relatively thin shield layer and thus can use a relatively large conductive core to realize better signal transmission.

An objective of the invention is to provide a cable, which comprises:

a conductor for transmitting electrical signals;
an insulating layer covering the conductor along the length direction of the cable; and
a shield layer covering the insulating layer along the length direction of the cable,
wherein the shield layer comprises multiple conductive flat wires which are spirally wound along the length direction of the cable to cover the insulating layer, and wherein the conductive flat wires are parallel to each other and do not overlap with each other.

In some embodiments of the invention, the shield layer comprises five to twelve conductive flat wires.

In some embodiments of the invention, the conductive flat wires each has a width and a thickness in the direction perpendicular to the length direction of the conductive flat wire, wherein the width is larger than the thickness and ranges from 0.05 mm to 0.8 mm.

In some embodiments of the invention, the conductive flat wires each has a width and a thickness in the direction perpendicular to the length direction of the conductive flat wire, wherein the width is larger than the thickness and the thickness ranges from 0.001 mm to 0.08 mm.

In some embodiments of the invention, the conductive flat wires are provided by flattening conductive round wires, and the conductive flat wires each has a width and a thickness in the direction perpendicular to the length direction of the conductive flat wire, wherein the width is larger than the thickness, and the ratio of the diameter of the conductive round wire to the thickness of the conductive flat wire (i.e., the diameter of the conductive round wire/the thickness of the conductive flat wire) ranges from 1 to 6.

In some embodiments of the invention, the conductive flat wires are selected from the group consisting of copper wires, copper base alloy wires, copper wires with a metal coating, copper base alloy wires with a metal coating, and combinations thereof.

In some embodiments of the invention, the conductor is a copper-containing conductor.

In some embodiments of the invention, the material of the insulating layer is selected from the group consisting of polyethylene terephthalate (PET), polyethylene (PE), polypropylene (PP), polytetrafluoroethylene (PTFE), copolymers of tetrafluoroethylene and perfluoroethers (PFA), copolymers of hexafluoropropylene and tetrafluoroethylene (FEP), polyvinyl chloride (PVC), silicone rubber, thermoplastic elastomers (TPE), and combinations thereof.

In some embodiments of the invention, the cable further comprises a protective layer covering the shield layer along the length direction of the cable. The material of the protective layer is selected from the group consisting of polyethylene terephthalate (PET), polyethylene (PE), polypropylene (PP), polytetrafluoroethylene (PTFE), copolymers of tetrafluoroethylene and perfluoroethers (PFA), copolymers of hexafluoropropylene and tetrafluoroethylene (FEP), polyvinyl chloride (PVC), silicone rubber, thermoplastic elastomers (TPE), and combinations thereof.

To render the above objectives, technical features and advantages of the invention more apparent, the invention will be described in detail with reference to some embodiments hereinafter.

### BRIEF DESCRIPTION OF THE DRAWINGS

FIG. 1 is a schematic drawing of an embodiment of the cable of the invention.

FIG. 2A is a cross-sectional drawing of an embodiment of the cable of the invention.

FIG. 2B is a cross-sectional drawing of an embodiment of the cable of the invention.

FIG. 3A is a cross-sectional drawing of an embodiment of the cable of the invention.

FIG. 3B is a cross-sectional drawing of an embodiment of the cable of the invention.

FIG. 4A is a cross-sectional drawing of a conductive flat wire of an embodiment of the cable of the invention.

FIG. 4B is a cross-sectional drawing of a conductive flat wire of an embodiment of the cable of the invention.

FIG. 4C is a cross-sectional drawing of a conductive flat wire of an embodiment of the cable of the invention.

### DESCRIPTION OF THE PREFERRED EMBODIMENTS

Hereinafter, some embodiments of the invention will be described in detail. However, the invention may be embodied in various embodiments and should not be limited to the embodiments described in the specification.

Unless additionally explained, the expressions “a,” “the,” or the like recited in the specification and the claims should include both the singular and the plural forms.

1. Cable

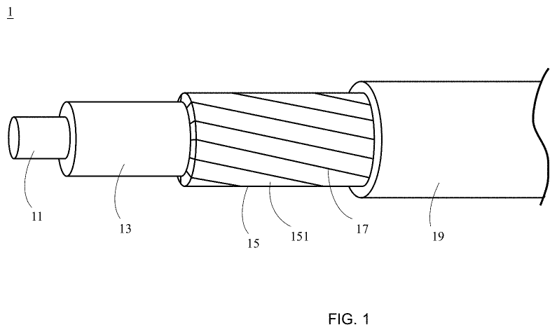

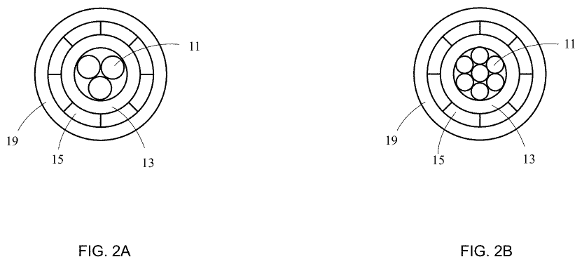

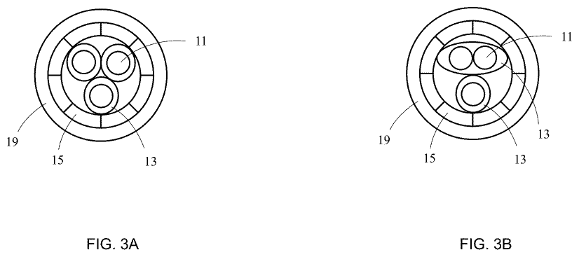

The cable of the invention can be co-axial or non-coaxial. FIG. 1 is a schematic drawing of an embodiment of the cable of the invention; and FIGS. 2A, FIG. 2B, FIG. 3A and FIG. 3B are cross-sectional drawings of some embodiments of the cable of the invention. As shown in the drawings, cable 1 comprises a conductor 11, an insulating layer 13 covering the conductor along the length direction of the cable, a shield layer 15 covering the insulating layer along the length direction of the cable, and a protective layer 19 covering the shield layer along the length direction of the cable. The cable of the invention requires less manufacturing time and cost; and for a given cable size, the cable of the invention has a relatively thin shield layer and thus can use a relatively large conductive core to realize better signal transmission. The detailed descriptions of each portion of the cable of the invention are provided below.

1.1. Conductor

Conductor 11 transmits signals and can consist of one conductive wire (as shown in FIG. 1) or multiple conductive wires. The number of conductive wires is not particularly limited. FIG. 2A shows an embodiment where conductor 11 consists of three conductive wires, and FIG. 2B shows an embodiment where conductor 11 consists of seven conductive wires. But the invention is not limited to these embodiments. The conductive wires can be wrapped in a single insulating layer 13 as shown in FIG. 2A and FIG. 2B or in different insulating layers 13 as shown in FIG. 3A and FIG. 3B.

The material of conductor 11 is not particularly limited but can be any conventional signal transmission material applicable in cables. Examples of the conventional signal transmission material include but are not limited to a copper-containing conductor (i.e., a conductor consisting of copper-containing conductive wires) and a copper conductor (i.e., a conductor consisting of copper wires). In some embodiments of the invention, conductor 11 consists of annealed copper wires, annealed graphene copper alloy wires, or hard copper wires.

1.2. Insulating Layer

The insulating layer 13 provide insulation for the conductor 11. The thickness of the insulating layer 13 is not particularly limited as long as the insulating layer 13 can provide the required insulation. The material of the insulating layer 13 can be any conventional insulation material applicable in cables. Examples of the conventional insulation material include but are not limited to the material selected from the group consisting of polyethylene terephthalate (PET), polyethylene (PE), polypropylene (PP), polytetrafluoroethylene (PTFE), copolymers of tetrafluoroethylene and perfluoroethers (PFA), copolymers of hexafluoropropylene and tetrafluoroethylene (FEP), polyvinyl chloride (PVC), silicone rubber, thermoplastic elastomers (TPEs), and combinations thereof. Examples of thermoplastic elastomers include but are not limited to styrenic thermoplastic elastomers, olefinic thermoplastic elastomers, thermoplastic polyurethanes, and thermoplastic polyesters. In some embodiments of the invention, the material of the insulating layer 13 is polytetrafluoroethylene (PTFE), copolymers of hexafluoropropylene and tetrafluoroethylene (FEP), or a combination thereof

1.3. Shield Layer

As shown in FIG. 1, in the cable of the invention, the shield layer 15 is provided by multiple conductive flat wires 151 which are spirally wound along the length direction of cable 1 to cover the insulating layer 13, and wherein the conductive flat wires 151 are parallel to each other and do not overlap with each other.

The number of the conductive flat wires 151 is not particularly limited but can be adjusted depending on such as the size of the insulating layer 13 or the size of the conductive flat wires 151. In some embodiments of the invention, the shield layer 15 is consisting of five to twelve conductive flat wires, such as five, six, seven, eight, nine, ten, eleven, or twelve conductive flat wires, but the invention is not limited thereto.

The size of the conductive flat wires 151 is not particularly limited but can be adjusted depending on the needs. In the preferred embodiments of the invention, the conductive flat wires 151 each has a width and a thickness in the direction perpendicular to the length direction of the conductive flat wire, wherein the width is larger than the thickness. The width ranges from 0.05 mm to 0.8 mm, preferably from 0.06 mm to 0.75 mm, and the thickness ranges from 0.001 mm to 0.08 mm, preferably from 0.002 mm to 0.07 mm. For example, the width of the conductive flat wires 151 can be 0.05 mm, 0.06 mm, 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.65 mm, 0.7 mm, 0.75 mm, or 0.8 mm; and the thickness of the conductive flat wires 151 can be 0.001 mm, 0.002 mm, 0.005 mm, 0.01 mm, 0.015 mm, 0.02 mm, 0.025 mm, 0.03 mm, 0.035 mm, 0.04 mm, 0.045 mm, 0.05 mm, 0.055 mm, 0.06 mm, 0.065 mm, 0.07 mm, 0.075 mm, or 0.08 mm.

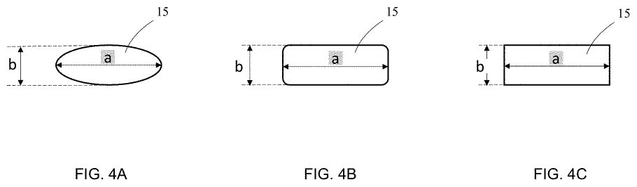

The conductive flat wire 151 is a conductive wire having a cross-section perpendicular to the length direction of the conductive wire, wherein the width of the cross-section is larger than the thickness (or “height”) of the cross-section. The shape of the cross-section is not particularly limited. For example, FIGS. 4A, FIG. 4B and FIG. 4C are cross-sectional drawings of conductive flat wires of some embodiments of the cable of the invention. As shown in the drawings, the cross-section of the conductive flat wire 151 can be an oval shape (i.e., not in a real circular shape, FIG. 4A), a round rectangular shape (FIG. 4B), or a rectangular shape (FIG. 4C), and the cross-section has a width “a” and a thickness “b”, a>b. But the invention is not limited to these embodiments. In some embodiments of the invention, the conductive flat wires 151 are provided by flattening conductive round wires and thus has a cross-section similar to that shown in FIG. 4A, wherein the cross-section of the conductive flat wires has a width and a thickness, the width is larger than the thickness, and the ratio of the diameter of the conductive round wire to the thickness of the conductive flat wire (i.e., the diameter of the conductive round wire/the thickness of the conductive flat wire) ranges from 1 to 6, more specifically 2 to 5. For example, the ratio of the diameter of the conductive round wire to the thickness of the conductive flat wire can be 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, or 4.9.

Gap 17 may or may not exist between the conductive flat wires 151 (i.e., the conductive flat wires 151 are not in contact with each other, or the conductive flat wires 151 are in contact with each other). However, in terms of sufficient shield effect, it is preferred to control the size of gap 17 in such a way that the shielding coverage of the shield layer 15 is 85% or more, e.g., 86% or more, 86.5% or more, 87% or more, 87.5% or more, 88% or more, 88.5% or more, 89% or more, 89.5% or more, 90% or more, 90.5% or more, 91% or more, 91.5% or more, 92% or more, 92.5% or more, 93% or more, 93.5% or more, 94% or more, 94.5% or more, 95% or more, 95.5% or more, 96% or more, 96.5% or more, 97% or more, 97.5% or more, 98% or more, 98.5% or more, 99% or more, or 99.5% or more. Without being restricted by any theories, it is believed that the higher the shielding coverage of the shield layer 15, the better the shielding effect.

The material of the conductive flat wires 151 is not particularly limited but can be any conventional shield material applicable in cables. The conventional shield material includes but is not limited to the wires selected from the group consisting of copper wires, copper-base alloy wires, copper wires with a metal coating, copper-base alloy wires with a metal coating, and combinations thereof. Examples of the copper wires with metal coating or copper-base alloy wires with metal coating include but are not limited to copper wires with silver coating or copper-base alloy wires with silver coating, copper wires with tin coating or copper-base alloy wires with tin coating, and copper wires with nickel coating or copper-base alloy wires with nickel coating. In some embodiments of the invention, the conductive flat wires 151 are oxygen-free copper flat wires.

1.4. Protective Layer

The protective layer 19 prevent cable 1 from damage due to extrinsic causes. The thickness of the protective layer 19 is not particularly limited as long as the protective layer can provide the required protection. The material of the protective layer 19 can be any conventional protective material applicable in cables. Examples of the conventional protective material include but are not limited to the materials selected from the group consisting of polyethylene terephthalate (PET), polyethylene (PE), polypropylene (PP), polytetrafluoroethylene (PTFE), copolymers of tetrafluoroethylene and perfluoroethers (PFA), copolymers of hexafluoropropylene and tetrafluoroethylene (FEP), polyvinyl chloride (PVC), silicone rubber, thermoplastic elastomers (TPEs), and combinations thereof. Examples of thermoplastic elastomers include but are not limited to styrenic thermoplastic elastomers, olefinic thermoplastic elastomers, thermoplastic polyurethanes, and thermoplastic polyesters. In some embodiments of the invention, the material of the protective layer 19 is polyethylene terephthalate (PET).

The above examples are used to illustrate the principle and efficacy of the invention and show the inventive features thereof but are not used to limit the scope of the invention. People skilled in this field may proceed with a variety of modifications and replacements based on the disclosures and suggestions of the invention as described. Therefore, the scope of protection of the invention is that as defined in the claims as appended.

### BRIEF DESCRIPTION OF REFERENCE NUMERALS

1: cable
11: conductor
13: insulating layer
15: shield layer
151: conductive flat wire
17: gap
19: protective layer
a: width
b: thickness

What is claimed is:

1. A cable, comprising:
a conductor for transmitting electrical signals;
an insulating layer covering the conductor along the length direction of the cable; and
a shield layer covering the insulating layer along the length direction of the cable,
wherein the shield layer comprises multiple conductive flat wires which are spirally wound along the length direction of the cable to cover the insulating layer, and wherein the conductive flat wires are parallel to each other and do not overlap with each other.

2. The cable of claim 1, wherein the shield layer comprises five to twelve conductive flat wires.

3. The cable of claim 1, wherein the conductive flat wires each has a width and a thickness in the direction perpendicular to the length direction of the conductive flat wire, wherein the width is larger than the thickness and ranges from 0.05 mm to 0.8 mm.

4. The cable of claim 1, wherein the conductive flat wires each has a width and a thickness in the direction perpendicular to the length direction of the conductive flat wire, wherein the width is larger than the thickness and the thickness ranges from 0.001 mm to 0.08 mm.

5. The cable of claim 1, wherein the conductive flat wires are provided by flattening conductive round wires, and the conductive flat wires each has a width and a thickness in the direction perpendicular to the length direction of the conductive flat wire, wherein the width is larger than the thickness, and the ratio of the diameter of the conductive round wire to the thickness of the conductive flat wire ranges from 1 to 6.

6. The cable of claim 1, wherein the conductive flat wires are selected from the group consisting of copper wires, copper base alloy wires, copper wires with a metal coating, copper-base alloy wires with a metal coating, and combinations thereof.

7. The cable of claim 2, wherein the conductive flat wires are selected from the group consisting of copper wires, copper base alloy wires, copper wires with a metal coating, copper-base alloy wires with a metal coating, and combinations thereof.

8. The cable of claim 3, wherein the conductive flat wires are selected from the group consisting of copper wires, copper-base alloy wires, copper wires with a metal coating, copper-base alloy wires with a metal coating, and combinations thereof.

9. The cable of claim 1, wherein the conductor is a copper-containing conductor.

10. The cable of claim 2, wherein the conductor is a copper-containing conductor.

11. The cable of claim 3, wherein the conductor is a copper-containing conductor.

12. The cable of claim 1, wherein the material of the insulating layer is selected from the group consisting of polyethylene terephthalate (PET), polyethylene (PE), polypropylene (PP), polytetrafluoroethylene (PTFE), copolymers of tetrafluoroethylene and perfluoroethers (PFA), copolymers of hexafluoropropylene and tetrafluoroethylene (FEP), polyvinyl chloride (PVC), silicone rubber, thermoplastic elastomers, and combinations thereof.

13. The cable of claim 2, wherein the material of the insulating layer is selected from the group consisting of polyethylene terephthalate (PET), polyethylene (PE), polypropylene (PP), polytetrafluoroethylene (PTFE), copolymers of tetrafluoroethylene and perfluoroethers (PFA), copolymers of hexafluoropropylene and tetrafluoroethylene (FEP), polyvinyl chloride (PVC), silicone rubber, thermoplastic elastomers, and combinations thereof.

14. The cable of claim 3, wherein the material of the insulating layer is selected from the group consisting of polyethylene terephthalate (PET), polyethylene (PE), polypropylene (PP), polytetrafluoroethylene (PTFE), copolymers of tetrafluoroethylene and perfluoroethers (PFA), copolymers of hexafluoropropylene and tetrafluoroethylene (FEP), polyvinyl chloride (PVC), silicone rubber, thermoplastic elastomers, and combinations thereof.

15. The cable of claim 1, further comprising a protective layer covering the shield layer along the length direction of the cable.

16. The cable of claim 2, further comprising a protective layer covering the shield layer along the length direction of the cable.

17. The cable of claim 3, further comprising a protective layer covering the shield layer along the length direction of the cable.

18. The cable of claim 15, wherein the material of the protective layer is selected from the group consisting of polyethylene terephthalate (PET), polyethylene (PE), polypropylene (PP), polytetrafluoroethylene (PTFE), copolymers of tetrafluoroethylene and perfluoroethers (PFA), copolymers of hexafluoropropylene and tetrafluoroethylene (FEP), polyvinyl chloride (PVC), silicone rubber, thermoplastic elastomers, and combinations thereof.

19. The cable of claim 16, wherein the material of the protective layer is selected from the group consisting of polyethylene terephthalate (PET), polyethylene (PE), polypropylene (PP), polytetrafluoroethylene (PTFE), copolymers of tetrafluoroethylene and perfluoroethers (PFA), copolymers of hexafluoropropylene and tetrafluoroethylene (FEP), polyvinyl chloride (PVC), silicone rubber, thermoplastic elastomers, and combinations thereof.

20. The cable of claim 17, wherein the material of the protective layer is selected from the group consisting of polyethylene terephthalate (PET), polyethylene (PE), polypropylene (PP), polytetrafluoroethylene (PTFE), copolymers of tetrafluoroethylene and perfluoroethers (PFA), copolymers of hexafluoropropylene and tetrafluoroethylene (FEP), polyvinyl chloride (PVC), silicone rubber, thermoplastic elastomers, and combinations thereof.
